(19) United States
(12) Patent Application Publication
(10) Pub. No.: US 2026/0073740 A1
(43) Pub. Date: Mar. 12, 2026

(54) PARKING LOT ZONE ESTIMATING DEVICE, AND PARKING LOT ZONE ESTIMATING METHOD

(71) Applicant: HONDA MOTOR CO., LTD., Tokyo (JP)

(72) Inventor: Sumit JAIN, Tokyo (JP)

(21) Appl. No.: 19/107,012

(22) PCT Filed: Aug. 15, 2023
(86) PCT No.: PCT/JP2023/029508

§ 371 Date: Feb. 26, 2025

(30) Foreign Application Priority Data
Sep. 5, 2022 (JP) 2022-140873

(51) Int. Cl. G07C 5/02; G06Q 30/0201; G06T 5/70; G06V 10/762; G08G 1/01

(52) U.S. Cl. CPC G07C 5/02; G06Q 30/02011; G06T 5/70; G06V 10/7635; G08G 1/0112

(57) ABSTRACT

A parking lot zone estimating device 30 comprises: a vehicle parking information recording unit 312 for determining that a vehicle is parked if there is no change in positional information for at least a predetermined period of time, and recording, as vehicle parking information, a parking location of the vehicle and a parking time that can be calculated from time information; a parking feature quantity calculating unit 313 for setting, as feature quantities of grids into which a region included in map information is divided, at least one of a parking frequency and a vehicle parking time, calculated on the basis of the vehicle parking information for each grid; and a facility parking lot estimating unit 314 for extracting the grids located within a prescribed range from a facility, and clustering the grids using the feature quantity to identify a parking lot of the facility.

### TECHNICAL FIELD

The present invention relates to a parking lot section estimation device and a parking lot section estimation method for determining a section of a parking lot of a facility based on positional information from a plurality of vehicles.

### BACKGROUND ART

Applications have been spreading in which FCD (Floating Car Data) including GPS positional information from a plurality of vehicles are received by a server and utilized for data analysis of facilities visited by the vehicles based on accumulated positional information and the like. In order to analyze the behavior/staying tendency of users from the vehicle data, section information of the parking lot associated with the place is required. For example, Patent Document 1 (paragraph 0029, FIG. 4, etc.) discloses a technique which defines facilities as polygons and determines visits based on whether they are within an area connecting vertices of the polygons. However, in the technique described in Patent Document 1, it is necessary to create map information including a section of a parking lot of a facility, and thus the cost burden of the map provider is large, which makes it difficult to realize. As another parking lot information acquisition method, it is known to use open data such as OSM (Open Street Map). However, OSM has low coverage and is difficult to maintain, and thus is not suitable for analyzing the behavior/staying tendency of users.

### CITATION LIST

### Patent Document

Patent Document 1: Japanese U.S. Pat. No. 3,539,629

### DISCLOSURE OF THE INVENTION

### Problems to be Solved by the Invention

In order to enable customer analysis to a facility by big data analysis or the like of an FCD acquired from vehicles, a parking lot section estimation device and a parking lot section estimation method capable of easily acquiring accurate parking lot section information associated with a facility are desired.

The present invention has been made in view of such a problem, and an object of the present invention is to provide a parking lot section estimation device and a parking lot section estimation method for determining a section of a parking lot of a facility by dividing a region in a predetermined range from the facility into a plurality of grid cells, performing clustering based on a feature amount of parking use calculated for each grid cell, and calculating a set of grid cells having similar feature amounts.

### Means for Solving the Problems

(1) A parking lot section estimation device (for example, a parking lot section estimation device 30 described later) includes: a map information storage (for example, a map information storage unit 321 described later) that stores map information including center positional information of a plurality of facilities; a receiver (for example, a receiver unit 311 described later) that receives continuous positional information together with time information from a plurality of vehicles; a vehicle parking information recorder (for example, a vehicle parking information recording unit 312 described later) that determines that a vehicle has been parked in a case in which the positional information has not changed for a predetermined period of time or more, and records a parking position of the vehicle, the time information, and a parking period of time that can be calculated based on the parking position and the time information, as vehicle parking information; a parking feature amount calculator (for example, a parking feature amount calculation unit 313 described later) that calculates a feature amount relating to at least any one of a parking frequency and a vehicle parking period of time in a predetermined period of time based on the vehicle parking information for each of a plurality of grid cells obtained by dividing a region included in the map information; and a facility parking lot estimator (a facility parking lot estimation unit 314 described later) that extracts grid cells positioned in a predetermined range from one of the plurality of facilities and performs clustering with the feature amount, to estimate a section of a parking lot of the facility.

According to the above (1), the region included in the map information is divided into a plurality of grid cells, and it is determined whether or not the grid cells are included in the parking lot section of the facility based on the feature amount relating to at least one of the parking frequency and the vehicle parking period of time calculated for each grid cell, such that it is possible to easily acquire the information of the parking lot section associated with the facility easily without manually creating the shape of the parking lot of the facility.
(2) In the parking lot section estimation device (for example, the parking lot section estimation device 30) as described in the above (1), the parking feature amount calculator (for example, the parking feature amount calculation unit 313) may calculate, for each of the grid cells, a total number of times of parking and an accumulated parking period of time of the total number of times of parking in the predetermined period of time, and set the total number of times of parking as a feature amount relating to the parking frequency and set the accumulated parking period of time of the total number of times of parking as a feature amount relating to the vehicle parking period of time.

According to the above (2), it is possible to distinguish between parking lots having different parking trends without manual intervention, and it is possible to specify more accurately a visited facility from the parking positional information.
(3) In the parking lot section estimation device (for example, the parking lot section estimation device 30) as described in the above (2), the parking feature amount calculator (for example, the parking feature amount calculation unit 313 described later) may further calculate an average parking period of time per vehicle based on the total number of times of parking and the accumulated parking period of time to set the average parking period of time per vehicle as a feature amount relating to the vehicle parking period of time.

According to (3) above, it is possible to distinguish between parking lots having different parking trends without manual intervention, and it is possible to more accurately specify a visited facility from the parking positional information.
(4) In the parking lot section estimation device (for example, the parking lot section estimation device 30) as described in any one of the above (1) to (3), the parking feature amount calculator (for example, the parking feature amount calculation unit 313 described later) further may calculate, for each of the grid cells, a feature amount relating to distance information from the facility based on a distance from the facility.

According to (4) above, it is possible to specify the visited facility more accurately from the parking positional information without manual intervention by including the distance from the facility of the grid cell in the feature amount.
(5) In the parking lot section estimation device (for example, the parking lot section estimation device 30) as described in any one of the above (1) to (3), the parking feature amount calculator (for example, the parking feature amount calculation unit 313) may further set, for each of the grid cells, at least one day of the week in the predetermined period of time, and calculate a parking frequency and/or a vehicle parking period of time in a period including only the set day of the week or a period not including the set day of the week.

According to the above (5), it is possible to more accurately specify whether or not each of the grid cells is included in a section of a parking lot of a facility based on, for example, business information including holiday information or business day information of the facility, without manual intervention.
(6) In the parking lot section estimation device (for example, the parking lot section estimation device 30) as described in any one of the above (1) to (3), the parking feature amount calculator (for example, the parking feature amount calculation unit 313) may further calculate, for each of the grid cells, a parking frequency and/or a vehicle parking period of time in a period including only a time slot of business hours of the facility or a period including only a time slot outside the business hours of the facility.

According to the above (6), it is possible to more accurately specify whether or not each of the grid cells is included in the section of the parking lot of the facility by excluding the grid cells including the parking information in the time slot other than the business hours of the facility.
(7) The parking lot section estimation device (for example, the parking lot section estimation device 30) as described in any one of the above (1) to (3) may further include a smoothing processor (for example, a smoothing processing unit 315 described later) that associates an image in which a pixel value 1 is associated with a grid cell estimated as a parking lot of the facility by the facility parking lot estimator or an image in which a pixel value 0 is associated with a grid cell estimated as not being a parking lot of the facility by the facility parking lot estimator with corresponding one of the grid cells, and perform filtering on each of the images by a smoothing filter in image processing, and the facility parking lot estimator (for example, the facility parking lot estimation unit 314 described later) may perform filtering on each of the images by the smoothing processor to correct a section of a parking lot of the facility estimated by performing clustering with the feature amount.

According to the above (7), it is possible to reduce the influence of data variation in the boundary estimation of the parking lot by correcting the section of the parking lot, without manual intervention.
(8) A parking lot section estimation method executed by a computer according to the present invention includes: a map information recording step of recording map information including center positional information of a plurality of facilities; a receiving step of receiving continuous positional information together with time information from a plurality of vehicles; a vehicle parking information recording step of determining that a vehicle has been parked in a case in which the positional information has not changed for a predetermined period of time or more, and recording a parking position of the vehicle, the time information, and a parking period of time that can be calculated based on the parking position and the time information, as vehicle parking information; a parking feature amount calculating step of calculating a feature amount relating to at least any one of a parking frequency and a vehicle parking period of time in a predetermined period of time based on the vehicle parking information for each of a plurality of grid cells obtained by dividing a region included in the map information; and a facility parking lot estimating step of extracting grid cells positioned in a predetermined range from a facility and performing clustering with the feature amount, to estimate a section of a parking lot of the facility.

According to the method (8), it is possible to obtain the same advantageous effects as those of the parking lot section estimation device of (1).

### Effects of the Invention

According to the present invention, it is possible to provide a parking lot section estimation device and a parking lot section estimation method for determining a section of a parking lot of a facility by dividing a region in a predetermined range from the facility into a plurality of grid cells, performing clustering based on a feature amount of parking use calculated for each grid cell, and calculating a set of grid cells having similar feature amounts.

### BRIEF DESCRIPTION OF THE DRAWINGS

FIG. 1 is a block diagram showing a basic configuration of an entire parking lot section estimation system according to an embodiment of the present invention;

FIG. 2 is a functional block diagram showing a functional configuration of an on-board navigation device according to an embodiment of the present invention;

FIG. 3 is a functional block diagram showing a functional configuration of a mobile terminal according to an embodiment of the present invention;

FIG. 4 is a functional block diagram showing a functional configuration of a parking lot section estimation device according to an embodiment of the present invention;

FIG. 5 is a diagram showing an example of a positional information database according to an embodiment of the present invention;

FIG. 6 is a diagram showing an example of a vehicle parking information table according to an embodiment of the present invention;

FIG. 7 is a diagram showing an example of a grid according to an embodiment of the present invention;

FIG. 8A is a diagram showing an example of a set of grid cells included in a facility parking lot estimated using the total number of times of parking (the cumulative number of times of parking) as a feature amount in an embodiment of the present invention;

FIG. 8B is a diagram showing an example of a set of grids included in the facility parking lot estimated using the accumulated parking period of time as a feature amount according to an embodiment of the present invention;

FIG. 8C is a diagram showing an example of a set of grids included in a facility parking lot estimated as an average parking period of time per vehicle as a feature amount according to an embodiment of the present invention;

FIG. 8D is a diagram showing a set of grids of a parking lot of a target facility estimated from three clustering results according to an embodiment of the present invention; and

FIG. 9 is a flowchart showing an operation of estimating a section shape of a parking lot of one facility according to an embodiment of the present invention.

### PREFERRED MODE FOR CARRYING OUT THE INVENTION

Hereinafter, a preferred embodiment of a parking lot section estimation system of the present invention will be described in detail with reference to the drawings.

### Entire Configuration of Parking Lot Section Estimation System 1

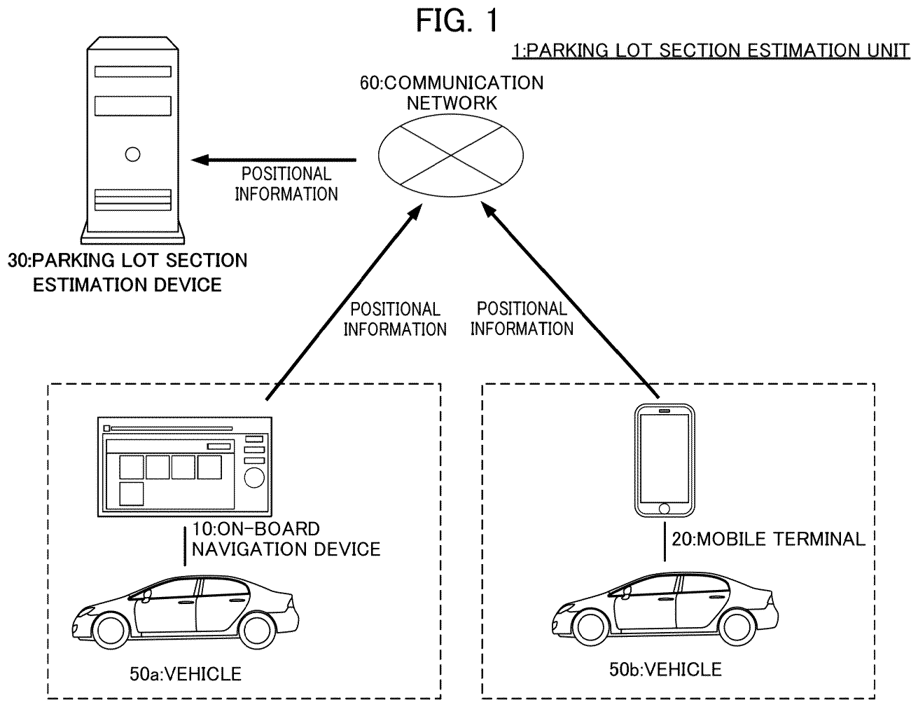

A parking lot section estimation system 1 according to a preferred embodiment of the present invention will be described. FIG. 1 shows an overall configuration of a parking lot section estimation system 1.

As shown in FIG. 1, the parking lot section estimation system 1 includes an on-board navigation device 10, a mobile terminal 20, and a parking lot section estimation device 30.

These devices and terminals are communicably connected to each other via a communication network 60. In the drawings, the information transmitted and received by each of the devices and each of the terminals is also shown, but these pieces of information are merely examples. In the present embodiment, information other than the illustrated information may be transmitted and received.

The on-board navigation device 10 is a device that performs navigation (route guidance) for a user who has boarded the vehicle 50a. The on-board navigation device 10 also has a function of measuring positional information of the on-board navigation device 10 (that is, positional information of the vehicle 50a). The on-board navigation device 10 performs route guidance from the current position to the destination based on the request of the user who has boarded the vehicle 50 and the measured positional information.

In addition, the on-board navigation device 10 appropriately transmits the measured positional information to the parking lot section estimation device 30 together with a mobile object ID, which is identification information for identifying the on-board navigation device 10, and the date and time information. Here, since the on-board navigation device 10 and the vehicle 50a are used as a one-to-one pair, the transmitted positional information can be substantially regarded as the positional information of the vehicle 50a.

Such an on-board navigation device 10 can be realized by a portable car navigation device installed in the vehicle 50a, which is a mobile object, or a PND (Portable Navigation Device) simply installed in the vehicle 50a, which is a mobile object.

The portable terminal 20 is a portable terminal used by a user who has boarded the vehicle 50b. The portable terminal 20 has a function of performing navigation (route guidance) and a function of measuring positional information of the portable terminal 20 (that is, positional information of the vehicle 50b), similarly to the on-board navigation device 10 described above.

Then, similarly to the above-described on-board navigation device 10, the mobile terminal 20 appropriately transmits the measured positional information to the parking lot section estimation device 30 together with the mobile object ID which is identification information for identifying the mobile terminal 20 and the date and time information.

Here, since the mobile terminal 20 and the vehicle 50b are used as a one-to-one pair, the positional information to be transmitted can be substantially regarded as the positional information of the vehicle 50b. Such a mobile terminal 20 can be realized by a smartphone, a mobile phone, a tablet terminal, a laptop computer, or other portable electronic devices.

It should be noted that, in the drawings, a pair of the on-board navigation device 10 and the vehicle 50a and a pair of the mobile terminal 20 and the vehicle 50b are shown, but the number of these pairs is not particularly limited, and any number of these pairs may be included in the present embodiment. Similarly, the number of parking lot section estimation devices 30 is not particularly limited, and any number of parking lot section estimation devices 30 may be included in the present embodiment.

In addition, in the following description, when the vehicle 50a on which the on-board navigation device 10 is mounted and the vehicle 50b on which the user who uses the mobile terminal 20 rides are referred to without distinction, they are simply referred to as a “vehicle 50” without adding any alphabet characters to their reference numerals. Further, the vehicle 50, the on-board navigation device 10 used in the vehicle 50, and the mobile terminal 20 move along with the movement of the vehicle 50. Therefore, in the following description, the vehicle 50, the on-board navigation device 10, and the mobile terminal 20 are also referred to as “mobile object” as appropriate.

The parking lot section estimation device 30 is a device capable of more accurately estimating a section of a parking lot of a facility in which each vehicle 50 is parked based on continuous positional information or the like received from a plurality of vehicles 50. With such a configuration, the parking lot section estimation device 30 can create, for example, a map including sections of the parking lot without manually creating the shape of the parking lot of the facility.

The vehicle 50 is a mobile object which the user of the on-board navigation device 10 or the mobile terminal 20 rides. The vehicle 50 is realized by, for example, a four-wheeled vehicle, a motorcycle, or the like.

The communication network 60 is realized by a network such as the Internet or a cellular phone network, or a network in which these are combined. A LAN (Local Area Network) may be included in a part of the network. Before describing the parking lot section estimation device 30, the on-board navigation device 10 and the mobile terminal 20 will be briefly described.

### Regarding On-board Navigation Device 10

The on-board navigation device 10 is supplied with power from the vehicle 50a, and is automatically activated when an ignition switch of the vehicle 50a is turned on (the engine is started) by a user who has boarded the vehicle 50a. Then, the on-board navigation device 10 operates until the ignition switch of the vehicle 50a is turned off (the engine is stopped) by the user who has boarded the vehicle 50a.

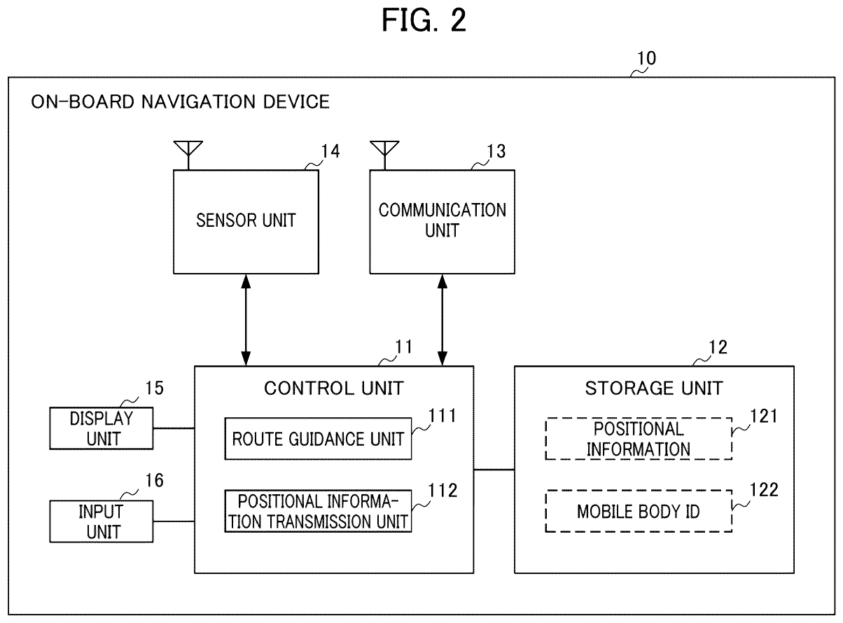

As shown in FIG. 2, the on-board navigation device 10 includes a control unit 11, a storage unit 12, a communication unit 13, a sensor unit 14, a display unit 15, and an input unit 16.

The control unit 11 includes an arithmetic processing unit such as a microprocessor, and controls each unit constituting the on-board navigation device 10. Details of the control unit 11 will be described later.

The storage unit 12 is constituted by semiconductor memory or the like, and stores programs including a control program called firmware or an operating system, a program for performing route guidance processing, and a program for performing transmission processing of positional information to the parking lot section estimation device 30, and various kinds of information such as map information including facility information and a facility ID for route guidance.

In the drawings, positional information 121 and mobile object ID 122, which are information unique to positional information transmission processing, are shown as information stored in the storage unit 12. The positional information 121 is positional information of the on-board navigation device 10 (that is, positional information of the vehicle 50a) measured by the sensor unit 14 described later. The positional information 121 may include not only the information indicating the measured position, but also the time at which the measurement of position is performed.

The mobile object ID 122 is information for identifying the on-board navigation device 10 and the vehicle 50a in which the on-board navigation device 10 is installed. As the mobile object ID 122, for example, a serial number uniquely assigned to the on-board navigation device 10 can be used. In addition, in order for the communication unit 13 to connect to the communication network 60 which is a network such as a mobile phone network, the telephone number assigned to SIM (Subscriber Identity Module) inserted into the communication unit 13 can be used as the mobile object ID 122. In addition, a VIN (vehicle identification number) or a number plate number uniquely assigned to the vehicle 50a can be used as the mobile object ID 122.

The communication unit 13 includes a DSP (Digital Signal Processor) or the like, and realizes wireless communication with another device (for example, the parking lot section estimation device 30) via the communication network 60 in conformity with standards such as LTE (Long Term Evolution), 4G (4th Generation), and 5G (5th Generation), and Wi-Fi (registered trademark). The communication unit 13 is used, for example, in order for the positional information transmission unit 112 to be described later to transmit the positional information 121 and the mobile object ID 122 stored in the storage unit 12 to the parking lot section estimation device 30. However, the data transmitted and received between the communication unit 13 and another device is not particularly limited, and information other than the positional information 121 and the mobile object ID 122 may be transmitted and received.

The sensor unit 14 includes, for example, a GPS (Global Positioning System) sensor, a gyro sensor, and an acceleration sensor. The sensor unit 14 has a function as a position detection unit that detects positional information, receives GPS satellite signals from a GPS sensor, and measures positional information (latitude and longitude) of the on-board navigation device 10. The measurement of position by the sensor unit 14 is performed at predetermined time intervals (for example, at intervals of 3 seconds) as described above. The measured positional information is stored in the storage unit 12 as the positional information 121. Since the GPS sensor can measure the altitude in addition to the latitude and longitude, the positional information may include the altitude in addition to the latitude and longitude. The sensor unit 14 can further improve the positioning accuracy of the positional information of the on-board navigation device 10 based on the angular velocity measured by the gyro sensor or the acceleration sensor or the acceleration. The display unit 15 includes a display device such as a liquid crystal display or an organic electroluminescent panel. The display unit 15 displays an image in response to an instruction from the control unit 11. The input unit 16 includes a physical switch called a numeric keypad, an input device (not shown) such as a touch panel provided so as to overlap the display surface of the display unit 15, and the like. In addition, although not shown, a speaker, a microphone, or the like may be provided. The speaker outputs sound to the driver, and the microphone collects sound or the like emitted by the driver. With such a configuration, it is possible to output information by voice from the speaker, or to input various selections and instructions by the driver, which are inputted by voice via the microphone, to the control unit 11 using voice recognition technology.

Next, the control unit 11 will be described in detail. The control unit 11 includes a microprocessor having a CPU (Central Processing Unit), RAM (Random access memory), ROM (Read Only Memory), I/O (Input/Output), and the like. The CPU executes each program read from the ROM or the storage unit 12, reads information from the RAM, the ROM, and the storage unit 12, writes information to the RAM and the storage unit 12, and exchanges signals with the communication unit 13, the sensor unit 14, the display unit 15, and the input unit 16.

In this manner, the hardware and the software (program) cooperate with each other to realize the processing of the present embodiment.

The control unit 11 includes a route guidance unit 111 and a positional information transmission unit 112 as functional blocks.

The route guidance unit 111 is a unit that performs route guidance processing to a destination such as a facility inputted or selected by a user, and is well known to those skilled in the art, and thus a detailed description thereof will be omitted.

The positional information transmission unit 112 is a unit that transmits the positional information 121 and the mobile object ID 122 stored in the storage unit 12 to the parking lot section estimation device 30 by wireless communication using the communication unit 13.

The transmission of the positional information 121 and the mobile object ID 122 to the parking lot section estimation device 30 by the positional information transmission unit 112 is periodically performed from when the ignition switch of the vehicle 50a is turned on (the engine is started) by the user who has boarded the vehicle 50a at the start of the drive and the on-board navigation device 10 is automatically activated, and until the ignition switch of the vehicle 50a is turned off (the engine is stopped) at the end of the drive on-board. For example, each time the sensor unit 14 performs the measurement of position at a predetermined time interval (for example, at an interval of 3 seconds), such a transmission is performed in real time. That is, such a transmission is performed in real time from the start of the drive to the end of the drive.

Further, instead of performing such a transmission to the parking lot section estimation device 30 in real time, a plurality of pieces of information may be collectively transmitted at a time (for example, the positional information 121 and the mobile object ID 122 updated at intervals of 3 seconds during 3 minutes are collected). That is, so-called burst transmission may be performed. The length of a predetermined time interval and whether to perform real-time transmission or burst transmission can be arbitrarily set according to the environment in which the present embodiment is applied. With such a configuration, by performing real-time transmission or burst transmission, the positional information transmission unit 112 transmits the positional information 121 and the mobile object ID 122 for specifying the movement path of the vehicle 50a measured by the sensor unit 14 to the parking lot section estimation device 30.

In this case, such a transmission to the parking lot section estimation device 30 can be performed by setting the position specified by the positional information 121 measured immediately after the ignition switch is turned on (the engine is started) and the on-board navigation device 10 is automatically activated as the initial vehicle position in the drive, that is, the departure position. Further, such a transmission to the parking lot section estimation device 30 can be performed by setting the position specified by the positional information 121 measured immediately before the ignition switch is turned off (the engine is stopped) as the final vehicle position in the drive, that is, the parking position. For example, such transmission to the parking lot section estimation device 30 is performed after adding information indicating being the positional information 121 expressing the departure position or being the positional information 121 expressing the parking position (for example, the value of a flag indicating these is set to 1 or the like) to the positional information 121. In addition, the positional information 121 (that is, the parking position) measured immediately before the ignition switch is turned off (the engine is stopped) may be transmitted when the ignition switch is turned on (the engine is started) and the on-board navigation device 10 is started again.

When burst transmission is performed, for example, in a case in which the route guidance unit 111 determines that the vehicle 50a has arrived at a destination such as a facility, the positional information transmission unit 112 can switch to perform transmission in real time. With such a configuration, it is possible to prevent a situation in which the ignition switch is turned off (the engine is stopped) after the vehicle arrives at a destination such as a facility and before the positional information 121 of the destination such as the facility is transmitted, and the positional information 121 of the destination such as the facility is not transmitted to the parking lot section estimation device 30.

Further, the positional information transmission unit 112 can transmit the speed information of the vehicle 50a to the parking lot section estimation device 30 together with the positional information 121 and the mobile object ID 122 described above.

### Regarding Mobile Terminal 20

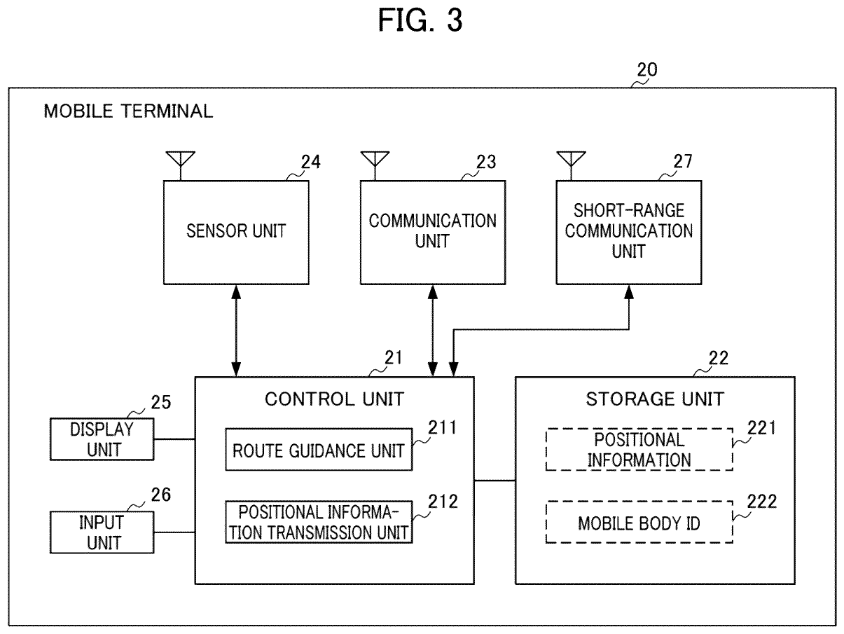

As shown in FIG. 3, the mobile terminal 20 includes a control unit 21, a storage unit 22, a communication unit 23, a sensor unit 24, a display unit 25, an input unit 26, and a short-range communication unit 27. Here, the control unit 21, the storage unit 22, the communication unit 23, the sensor unit 24, the display unit 25, and the input unit 26 have the same functions as the functional blocks of the same names included in the above-described on-board navigation device 10. That is, in the description of the on-board navigation device 10 described above, by replacing the wording “on-board navigation device 10″ with the wording ” mobile terminal 20″ and replacing the wording “vehicle 50a” with the wording “vehicle 50b”, the description of each functional block of the mobile terminal 20 is provided, and therefore, a redundant description is omitted.

On the other hand, since the portable terminal 20 is different from the on-board navigation device 10 in that it includes the short-range communication unit 27, the difference will be described below. The short-range communication unit 27 is a unit for performing non-contact short-range communication conforming to standards such as NFC (Near Field Communication) and Bluetooth (registered trademark) or wired short-range communication via a USB (Universal Serial Bus) cable or the like.

On the other hand, the vehicle 50b includes a short-range communication unit for communicating with the short-range communication unit 27. For example, an ECU (Electronic Control Unit) of the vehicle 50b includes a short-range communication unit. The case where the mobile terminal 20 can communicate with the ECU by short-range communication refers to a case where the mobile terminal 20 exists in the vehicle 50b. In this case, the positional information measured by the sensor unit 24 of the mobile terminal 20 corresponds to the positional information of the vehicle 50b.

Therefore, the mobile terminal 20 activates the positional information transmission unit 212 as long as the mobile terminal 20 can perform the short-range communication with the ECU via the short-range communication unit 27. Then, the activated positional information transmission unit 212 transmits the positional information 221 and the mobile object ID 222 for specifying the movement path of the vehicle 50b measured by the sensor unit 24 to the parking lot section estimation device 30 in the same manner as the positional information transmission unit 112 of the on-board navigation device 10.

For example, when the user carries the mobile terminal 20 and gets in the vehicle 50b, and turns on an activation switch of the vehicle 50b such as an ignition switch, the vehicle 50b and the mobile terminal 20 are connected (paired), and then the positional information 221 and the mobile object ID 222 measured by the mobile terminal 20 are transmitted from the mobile terminal 20 to the parking lot section estimation device 30. Further, when the activation switch of the vehicle 50b such as the ignition switch is turned off, the pairing between the vehicle 50b and the mobile terminal 20 is released.

When the vehicle 50b has a function of measuring the positional information, the positional information measured by the vehicle 50b, instead of the positional information measured by the sensor unit 24, may be transmitted to the parking lot section estimation device 30 as the positional information 121. In this case, the sensor unit 24 may be omitted from the mobile terminal 20.

### Regarding Parking Lot Section Estimation Device 30

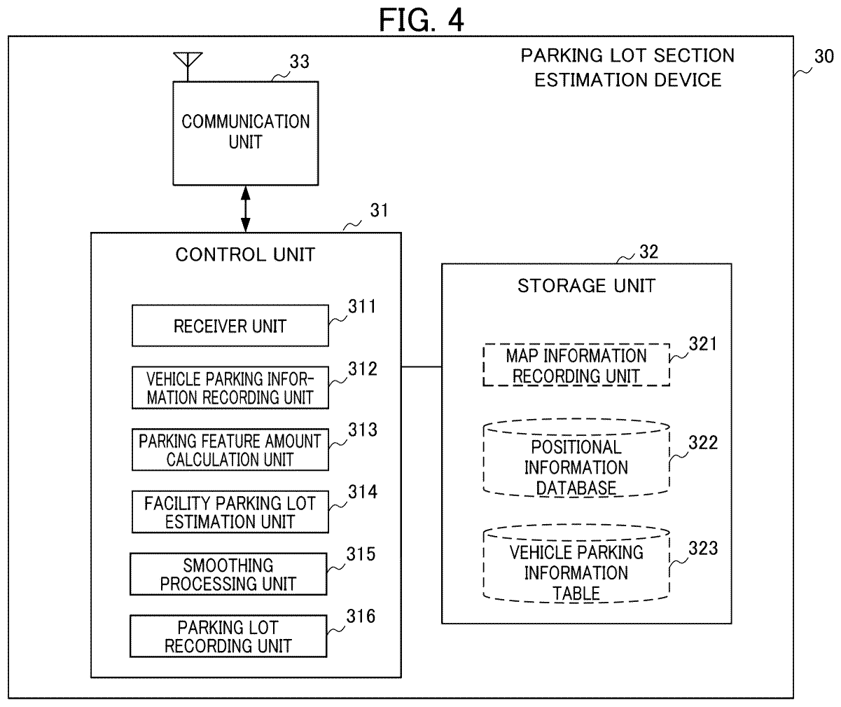

Next, functional blocks included in the parking lot section estimation device 30 will be described with reference to a block diagram of FIG. 4.

As shown in FIG. 4, the parking lot section estimation device 30 includes a control unit 31, a storage unit 32, and a communication unit 33.

The control unit 31 includes an arithmetic processing unit such as a microprocessor, and controls each unit constituting the parking lot section estimation device 30. Details of the control unit 31 will be described later.

The storage unit 32 is configured by semiconductor memory or the like, and stores various programs such as a control program called firmware or an operating system, a program for performing parking lot section estimation processing, and various other information such as map information. In the drawings, as information stored in the storage unit 32, a map information storage unit 321 that stores map information, a positional information database 322 that stores positional information of each vehicle 50, and a vehicle parking information table 323 that stores parking positional information of each vehicle 50 are shown, which are information related to parking lot section estimation processing.

The map information stored in the map information storage unit 321 includes, for each of a plurality of facilities, facility identification information (facility ID), a name of the facility, a facility type (and/or genre) related to the type of the facility, a telephone number, an address, business hours, center positional information indicating a center position (for example, latitude and longitude information) of the facility, and the like. Here, the facility type indicates, for example, a business category of a facility such as a convenience store, a hospital, or a car dealer. In addition to the map information, the storage unit 32 may include, for example, road network data including road information, display map data for displaying a background such as roads and a road map, positional information and type information of nodes (for example, intersections, bending points, end points, and the like of roads), positional information and type information of links which are routes connecting the nodes, link cost data related to cost information (for example, distance, required time, and the like) of all links, and the like.

The map information may be stored in advance in the map information storage unit 321, or may be downloaded as necessary from a server device (not shown) or the like connected to the communication network 60. Further, the map information may be appropriately modified in accordance with a user's input or the like.

The positional information database 322 refers to a database constructed based on the positional information 121 and the mobile object ID 122 received from the on-board navigation device 10 and the positional information 221 and the mobile object ID 222 received from the mobile terminal 20. The positional information database 322 is constructed and updated by each functional block included in the control unit 31. Details of the positional information database 322 will be described later.

As will be described later, the vehicle parking information table 323 refers to a table that stores positional information indicating that the vehicle parking information recording unit 312 has determined that the vehicle 50 was parked as a parking position of the vehicle in association with identification information of the vehicle 50. At this time, the vehicle parking information table 323 may store a parking period of time including the date and time information at the parking position in addition to the parking position.

In the following description, when the positional information 121 and the positional information 221 are described without being distinguished from each other, reference numerals are omitted and they are referred to as “positional information”. Similarly, when the mobile object ID 122 and the mobile object ID 222 are described without being distinguished from each other, reference numerals are omitted and referred to as “mobile object ID”.

The communication unit 33 includes a DSP or the like, and realizes wireless communication or wired communication with other devices (for example, the on-board navigation device 10, the mobile terminal 20, and the like) via the communication network 60 in conformity with standards such as LTE (Long Term Evolution), 4G (4th Generation), 5G (5th Generation), and Wi-Fi (registered trademark). The communication unit 33 is used, for example, to receive the positional information, the user information, and the mobile object ID transmitted from each of the on-board navigation device 10 and the portable terminal 20. However, the data transmitted and received between the communication unit 33 and another device is not particularly limited, and information other than these pieces of information may be transmitted and received.

Next, the control unit 31 will be described in detail.

The control unit 31 includes a microprocessor having a CPU, RAM, ROM, an I/O, and the like. The CPU executes each program read from the ROM or the storage unit 32, reads information from the RAM, the ROM, and the storage unit 32 when executing each program, writes information to the RAM and the storage unit 32, and exchanges signals with the communication unit 33. In this manner, the hardware and the software (program) cooperate with each other to realize the processing of the present embodiment.

The control unit 31 includes, as functional blocks, a receiver unit 311, a vehicle parking information recording unit 312, a parking feature amount calculation unit 313, a facility parking lot estimation unit 314, a smoothing processing unit 315, and a parking lot recording unit 316.

The receiver unit 311 receives the continuous positional information from the plurality of vehicles 50 together with the time information. More specifically, the receiver unit 311 refers to a unit that updates the positional information database 322 based on the continuous positional information and the mobile object ID received from mobile object via the communication unit 33.

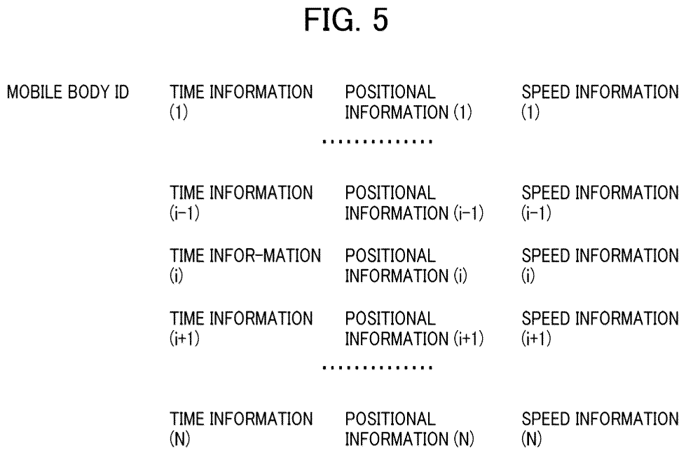

The positional information database 322 may store, for example, the positional information of the traveling vehicle during at least the most recent one-year period. In addition, the positional information database 322 may store the positional information of the traveling vehicle by, for example, prefecture, region, or the like. An example of the data structure of the positional information database 322 will be described with reference to FIG. 5. As shown in FIG. 5, the positional information database 322 may store “speed information” for each vehicle 50 in addition to “mobile object ID” and “continuous positional information and time information from the vehicle 50” received by the receiver unit 311.

As described above, the “mobile object ID” in the positional information database 322 refers to information for identifying the on-board navigation device 10 and the mobile terminal 20 that are the transmission sources of the positional information and the like, and the vehicle 50 on which these are mounted. The “positional information” in the positional information database 322 refers to all the continuous positional information received from mobile object from the start of transmission of the positional information or the like to the present time. The “time information” refers to time information at which the measurement of the positional information is performed. It is possible to specify the vehicle parking information including the parking position, the parking date and time, and the like based on all the continuous positional information and the time information. In a case in which the speed information is transmitted together with the positional information from mobile object, the received speed information is stored in association with the time information and the positional information.

The vehicle parking information recording unit 312 determines, based on the positional information database 322, that, in a case in which it is determined that the vehicle positional information has not changed for a predetermined period of time or more, the vehicle 50 has been parked.

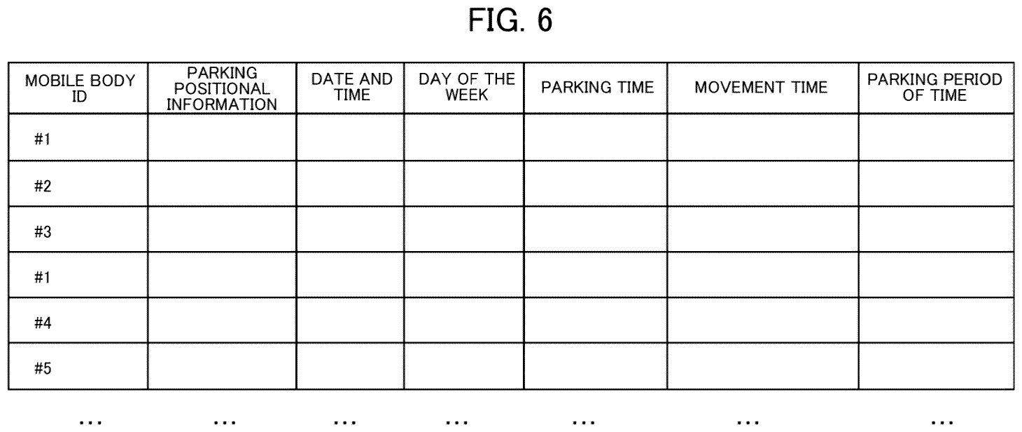

Further, when it is determined that the vehicle 50 was parked, the vehicle parking information recording unit 312 calculates the date, the day of the week, the parking time, the movement time, and the parking period of time of the vehicle 50. The vehicle parking information recording unit 312 sets the positional information indicating that it is determined that the vehicle 50 was parked as the parking position of the vehicle, and stores such information in the vehicle parking information table 323 in association with the identification information of the vehicle 50. FIG. 6 is a diagram showing an example of the vehicle parking information table 323. The vehicle parking information recording unit 312 stores the parking positional information, date and time information (date and time and day of the week) at the parking position, the parking time, the movement time, the parking period of time, and the like in the vehicle parking information table 323 together. Here, the parking time indicates the time when the mobile object was parked at the parking position, and the movement time indicates the time when the mobile object moved from the parking position. In the vehicle parking information table 323, for example, the collection period may be set as one year, and the vehicle parking information may be recorded and accumulated for each prefecture or region.

More specifically, for example, in a case in which the positional information has not been transmitted for a predetermined period of time after the last receipt of the positional information once the transmission of positional information, etc. was started, the vehicle parking information recording unit 312 may determine that the position corresponding to positional information received last is the parking position. In this case, the vehicle parking information recording unit 312 may calculate a predetermined time during which the positional information is not transmitted as the parking time of the vehicle 50. In addition, in a case in which the position corresponding to the positional information transmitted additionally does not change for a predetermined time or more, this position may be determined to be the parking position. In this case, the vehicle parking information recording unit 312 may calculate the time during which the position does not change as the parking time of the vehicle 50. In addition, in a case in which the interval between the respective times at which the adjacent positional information is measured in the continuous positional information received from the vehicle 50 exceeds or is equal to or longer than a first time set in advance, and is lower than or equal to a second time set in advance, and any of the speed information of the adjacent positional information is lower than or equal to a predetermined speed Vo set in advance, the vehicle parking information recording unit 312 may determine that the vehicle has been stopped. In this case, the vehicle parking information recording unit 312 may calculate, as the parking period of time of the vehicle 50, an interval between times at which the adjacent positional information is measured. Here, the predetermined speed Vo may be, for example, on the order of the speed at the time of stopping in the parking lot. Further, the speed may be 0 km/h. The speed may be set according to a feature of each vehicle 50 (a feature of the driver during driving). With such a configuration, for example, even if the device cannot transmit the positional information when the ignition is turned on and/or when the ignition is turned off, it is possible to specify the information that allows that vehicle to be expected to be stopped. In a case in which the transmission of the positional information of the vehicle 50 when the ignition is turned off as in the on-board navigation device 10 in the current engine vehicle, for example, the current position transmitted immediately before the reception of the positional information of the vehicle 50 is stopped may be set as the parking position. In this case, the vehicle parking information recording unit 312 may calculate, as the parking period of time of the vehicle 50, a period of time from when the transmission of the positional information of the vehicle 50 is stopped to when the transmission of the positional information of the vehicle 50 is started next.

Similarly, in a case in which the vehicle 50 starts the transmission of the positional information of the vehicle 50 when the ignition is turned on, for example, as in the on-board navigation device 10 in the current engine vehicle, the current position at which the reception of the positional information of the vehicle 50 is started may be set as the parking position. In this case, the vehicle parking information recording unit 312 may calculate, as the parking period of time of the vehicle 50, a time difference from the time when the transmission of the positional information of the vehicle 50 is stopped, before starting the reception of the positional information of the vehicle 50. In addition, in a case in which the stop signal information can be transmitted even when the vehicle 50 is stopped as in an electric vehicle, for example, the current position indicated by the stop signal or the nearest positional information of the positional information of the vehicle 50 may be set as the parking position. In this case, the vehicle parking information recording unit 312 may calculate, as the parking period of time of the vehicle 50, the period of time from the reception of the stop signal information to the next reception of the activation signal information or the positional information.

Similarly, when the vehicle 50 can transmit the activation signal information at the time of activation of the vehicle 50, for example, as in an electric vehicle, the current position indicated by the activation signal may be set as the parking position. In this case, the vehicle parking information recording unit 312 may calculate, as the parking period of time of the vehicle 50, a time difference from the time when the stop signal information or the last position signal from the vehicle 50 is received before the activation signal information is received.

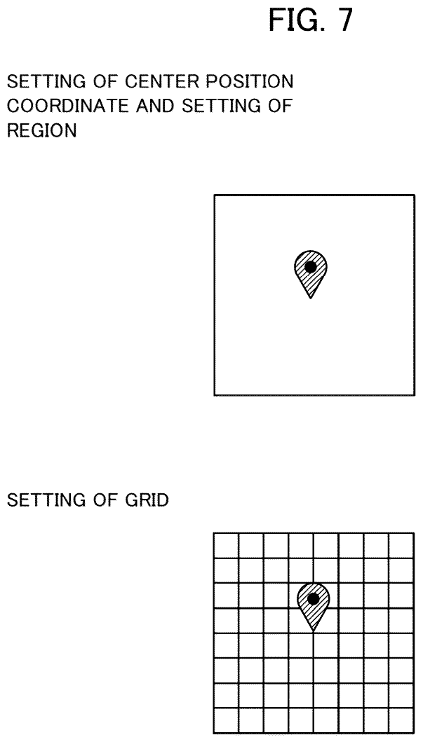

The parking feature amount calculation unit 313 sets, for example, a region including a target facility (including a parking lot) included in the map information (for example, center position coordinates of the target facility), and divides the region into a plurality of grids (also referred to as “grating”). Here, the grid may be an azimuthal grid (e.g., having a side length of 1.5 m to about 1.5 m) in a Cartesian coordinate system as shown in FIG. 7. This size is a value close to the size of the vehicle and, for example, a predetermined region including the target facility can be divided into N×N (N is a natural number) grids e(i, j) (1≤i≤N, 1≤j≤N). In this way, the facility parking lot estimation unit 314 described later can more finely estimate the shape of the section of the parking lot. In addition, a grid (e.g., a road portion) in which the vehicle is not parked is excluded from the set of grids. Although not shown, the grid may be a radial grid in a polar coordinate system or may be a grid having an arbitrary shape. When a target facility for specifying a parking lot is designated by the user, the parking feature amount calculation unit 313 may extract parking information for a predetermined period from the vehicle parking information table 323 with each grid cell e(i, j) including the target facility and around the target facility as a target, and calculate a feature amount related to the number of vehicles parked and the parking time.

Specifically, the parking feature amount calculation unit 313 can extract, from the vehicle parking information table 323, vehicle parking information stored for each grid cell e(i, j) within a predetermined period and having a position included in each of the grid cells as parking position information, thereby calculating the total number of vehicles parked for each of the grid cells e(i, j) within a predetermined period (also referred to as “the total number of times of parking” or “the cumulative number of times of parking”). The total number of vehicles parked in each grid cell e(i, j) is represented by v(i, j). In addition, the parking feature amount calculation unit 313 can calculate a total period of time of parking times (accumulated parking period of time) of each vehicle parked for each grid cell e(i, j) within a predetermined period. The accumulated parking period of time of the vehicle parked in each grid cell e(i, j) is represented by s(i, j). With such a configuration, the parking feature amount calculation unit 313 can calculate the average parking period of time a(i, j) per one vehicle parked in each grid cell e(i, j) in a predetermined period based on the total number of times of parking (the cumulative number of times of parking) v(i, j) and the accumulated parking period of time s(i, j) calculated for each grid cell e(i, j). a(i, j)=s(i, j)/v(i, j) (Expression 1) The parking feature amount calculation unit 313 may set the total number of times of parking v(i, j) in a predetermined period calculated for each grid cell e(i, j) as a parking frequency as a feature amount in the predetermined period of the grid cell, and set the accumulated parking period of time s(i, j) as a vehicle parking period of time as a feature amount in the predetermined period of the grid cell. Further, the parking feature amount calculating unit 313 can set the average parking period of time a(i, j) per vehicle calculated for each grid cell e(i, j) as the vehicle parking period of time as the feature amount in the predetermined period of the grid cell e(i, j). Further, at least any one of the total number of times of parking v(i, j), the accumulated parking period of time s(i, j), and the average parking period of time a(i, j) may be applied as the feature amount in the predetermined period of the grid cell e(i, j). Further, the parking feature amount calculation unit 313 may calculate a distance d(i, j) from a facility (for example, center position coordinates of the facility) set for each grid cell e(i, j), and may set distance information d(i, j) from the facility as a feature amount related to the facility of the grid cell.

The feature amount in the predetermined period for each grid cell e(i, j) is not limited to the above-described value. An arbitrary statistical value based on vehicle information parked in the grid cell e(i, j) within a predetermined period may be applied. For example, a value (average number of parking units per day) obtained by dividing the total number of times of parking (the cumulative number of times of parking) by a predetermined period (number of days) may be applied as the parking frequency as the feature amount in a predetermined period of the grid cell e(i, j). Further, as the vehicle parking period of time as the feature amount in the predetermined period of the grid cell, an intermediate value of the parking period of time of each of the parked vehicles may be applied. In addition, an arbitrary statistical value related to the parking period of time, for example, a feature amount in consideration of characteristics of the target facility such as the parking period of time in a specific time period of the target facility, may be applied.

For example, in a case in which the number of vehicles parked is significantly different depending on the time zone in the business hours of one day depending on the facility (for example, in a case in which the facility is a dining saloon, a restaurant, or the like, it is expected that the number of vehicles parked in a meal time is large), a set of the parking frequency (for example, the total number of vehicles) of the parked vehicles and the vehicle parking period of time calculated for each business hours in a predetermined period may be used as the feature amount. With such a configuration, the facility parking lot estimation unit 314, which will be described later, can determine that, even in a case in which the total number of times of parking and the vehicle parking period of time in a predetermined period are similar to each other in adjacent grid cells but the feature amounts for the respective business hours of these adjacent grids are not similar to each other, the adjacent grid cells are those of different facilities.

In addition, the parking feature amount calculation unit 313 may set at least one day of the week and set a period including only the set day of the week or a period not including the set day of the week as a predetermined period, thereby calculating the feature amount. For example, a holiday of the facility may be set as a day of the week. With such a configuration, the facility parking lot estimation unit 314, which will be described later, can exclude, from the parking lot of the facility, a grid cell located around the facility and having parking information on a holiday.

Similarly, the parking feature amount calculation unit 313 may set a period including only the business hours of the facility or only outside of the business hours as the predetermined period, thereby calculating the feature amount related to the facility of the grid cell. With such a configuration, the facility parking lot estimation unit 314, which will be described later, can exclude, from the parking lot of the facility, a grid cell located around the facility and having parking information outside the business hours.

The facility parking lot estimation unit 314 can estimate the shape of the parking lot of the target facility stored in the map information storage unit 321 based on the feature amount of each grid cell e(i, j) calculated by the parking feature amount calculation unit 313. The facility parking lot estimation unit 314 extracts grid cells e(i, j) included in a predetermined range from one facility designated by the user, and clusters each grid based on the feature amount of each of the grid cells calculated by the parking feature amount calculation unit 313. Specifically, the facility parking lot estimation unit 314 may perform clustering based on whether or not the grid cell e(i, j) is a parking lot of the target facility. The facility parking lot estimation unit 314 may create two clusters from a set of grid cells e(i, j) (1≤i≤N, 1≤j≤N) based on the K-means method in which K=2, for example. In this case, the predetermined range may be set so as to include another facility outside the one facility.

Further, for example, clustering may be performed based on a plurality of feature amounts including the number of times of parking, the average parking period of time, and the distance information from the facility. Clustering may be performed based on one feature amount. The facility parking lot estimation unit 314 clusters a set of grid cells using the feature amounts of the grids e(i, j) calculated by the parking feature amount calculation unit 313, thereby classifying grid cells having similar feature amounts as one cluster and grid cells having non-similar feature amounts as another cluster.

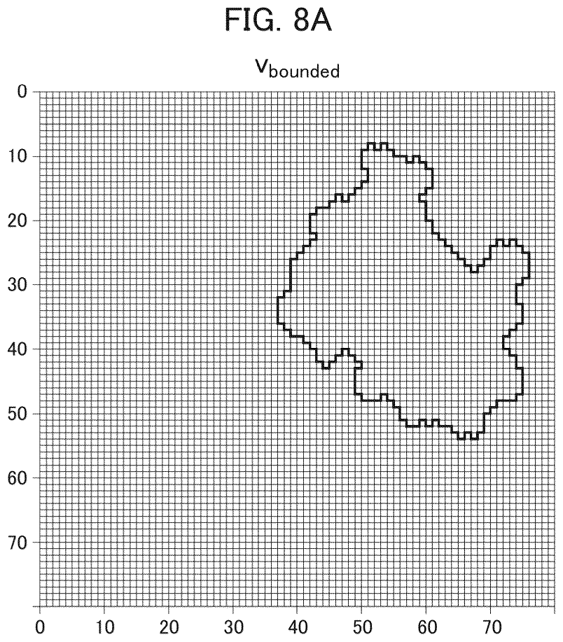

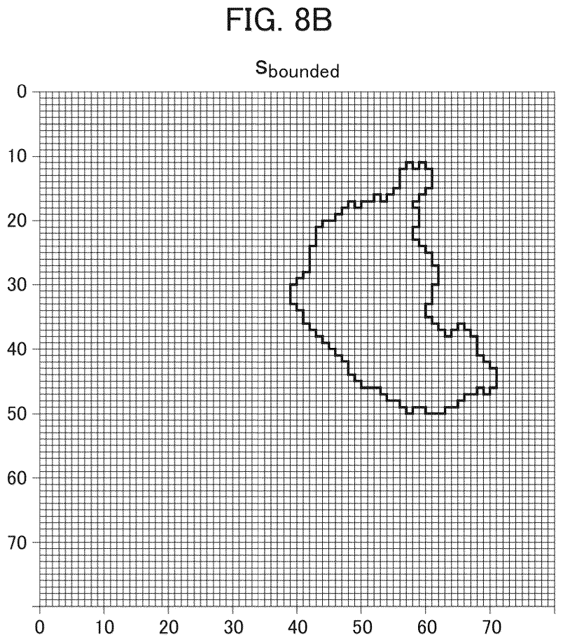

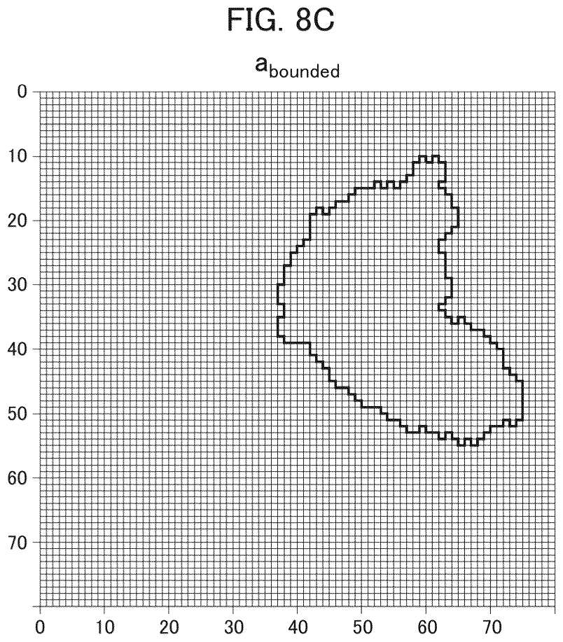

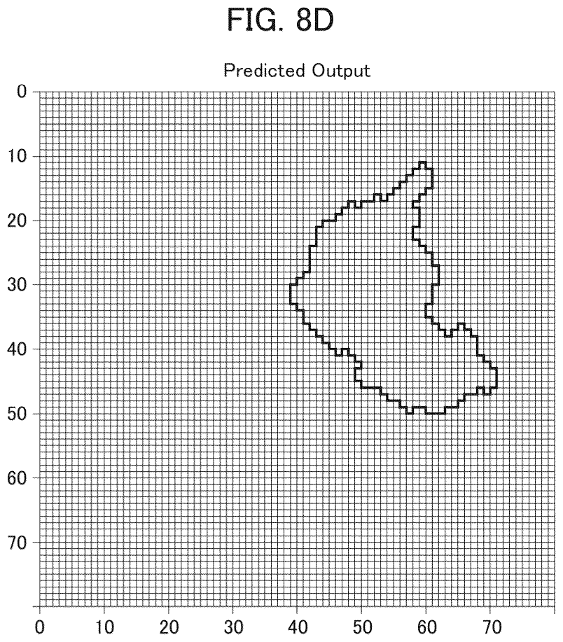

As described above, the facility parking lot estimation unit 314 may exclude road portions from all the grid cells included in each cluster to specify the grid cells as parking lot sections of the facility. Specifically, for example, when the feature amounts are similar between adjacent grid cells e(i, j) or when the feature amounts are similar between different grid cells e(i, j) included in the predetermined region, the facility parking lot estimation unit 314 can classify each of the two grid cells into the same cluster (a cluster of a parking lot of the target facility or another cluster). For example, FIG. 8A is a diagram showing an example of a set of grid cells included in a facility parking lot estimated using the total number of times of parking (the cumulative number of times of parking) v(i, j) as a feature amount. FIG. 8B is a diagram showing an example of a set of grid cells included in the facility parking lot estimated using the accumulated parking period of time s(i, j) as a feature amount. FIG. 8C is a diagram showing an example of a set of grid cells included in the facility parking lot estimated using the average parking period of time a(i, j) per vehicle as a feature amount. With such a configuration, the facility parking lot estimation unit 314 can distinguish between parking lots having different parking trends based on the feature amount, and can more accurately specify a section of the parking lot of the target facility from the parking positional information. For example, when the average parking period of time of the vehicle in relation to the convenience store is compared with the average parking period of time of the vehicle in relation to the supermarket, it is estimated that the average parking period of time of the vehicle in relation to the supermarket tends to be longer. Then, when the target facility is a convenience store, even when the supermarket parking lot is located together in the predetermined region, the facility parking lot estimation unit 314 still can determine that the grid cell included in the supermarket parking lot is not the parking lot of the target facility (convenience store).

As described above, when the grid cells are classified into two clusters, the facility parking lot estimation unit 314 can further improve the accuracy of the parking lot section of the target facility by, for example, excluding grid cells each having parking information outside the business hours of the target facility on the basis of the business hours, the business day, or the like of the target facility.

In addition, the facility parking lot estimation unit 314 performs clustering by applying a plurality of sets, each including a different feature amount as the feature amount of the grid cell e(i, j) as described above, and obtaining the intersection of the set of grids estimated as the parking lot of the target facility based on the clustering result obtained for each of the different sets, thereby making it possible to more accurately estimate whether the grid cell e(i, j) is a grid cell of the target facility (to increase reliability).

For example, as shown in FIG. 8A, FIG. 8B, and FIG. 8C, the facility parking lot estimation unit 314 individually applies the total number of times of parking (the cumulative number of times of parking) v(i, j), the accumulated parking period of time s(i, j), and the average parking period of time a(i, j) per vehicle as the feature amounts of the grid cells e(i, j), and calculates the result of the clustering based on the total number of times of parking (the cumulative number of times of parking) v(i, j), the result of the clustering based on the accumulated parking period of time s(i, j), and the result of clustering based on the average parking period of time a(i, j) per vehicle, and thereafter takes the intersections of the respective facility parking lots, which serve as the estimated clustering results, thereby making it possible to more accurately estimate whether or not the grid cell e(i, j) is a grid cell of the parking lot of the target facility. FIG. 8D is a diagram showing a set of grid cells of a parking lot of a target facility estimated from three clustering results.

With such a configuration, the facility parking lot estimation unit 314 may determine that the outline of the set of the grid cells e(i, j) determined as the parking lot of one facility is the shape information of the parking lot of the facility as the boundary line information of the parking lot of the facility.

### Smoothing Processor 315

When the facility parking lot estimation unit 314 classifies the grid cells into clusters, it is expected that there is no continuity in a part of the grid cells included in the same cluster. Specifically, for example, in a case in which, in a grid set estimated as a parking lot of a target facility, a part of the grid cells is isolated without connecting to another grid, or conversely a part of the grid subsets and another part of grid subsets are slightly connected by a few grid cells, a parking lot section of the facility may be smoothed by performing filter processing (for example, morphology processing) in image analysis such as closing or opening in image processing. Here, the morphology processing indicates processing of converting a binarized image into a smooth image. Here, as an example of filter processing in image analysis, the morphology processing based on shrinkage processing and expansion processing will be described. In the expansion processing, for example, if at least one white pixel exists in the vicinity of the pixel of interest in the monochrome binary image data, the pixel of interest is replaced with a white pixel to increase the white region (smoothing processing). In addition, examples of the smoothing processing include averaging filter processing as processing similar to the expansion processing. Conversely, in the contraction processing, if at least one black pixel exists in the vicinity of the pixel of interest in the monochrome binary image data, the pixel of interest is replaced with a black pixel to increase the black region (noise reduction processing). Examples of the morphology processing based on the contraction processing and the expansion processing include closing processing in which the expansion processing is performed the same number of times, and thereafter the contraction process is performed the same number of times, and opening processing in which the contraction process is performed the same number of times, and thereafter the expansion process is performed the same number of times. Here, a case where the closing processing is applied as the morphology processing will be described as an example.

Specifically, in the two grid sets classified into two clusters by the facility parking lot estimation unit 314, the smoothing processing unit 315 first associates the pixel value 1 (white pixels) with the grid cells estimated as the parking lot of the target facility, and associates the pixel value 0 (black pixels) with the grid cells estimated as not being the parking lot of the target facility. Accordingly, the smoothing processing unit 315 performs image conversion on the two clustered grid sets into a grid image including white pixels or a grid image including black pixels. Thereafter, the smoothing processing unit 315 can smooth the monochrome image by performing, for example, the expansion processing a predetermined number of times, and then performing the contraction processing a predetermined number of times on the monochrome image converted into the monochrome binary image.

The smoothing processing unit 315 can calculate the smoothed parking lot section of the facility by inversely converting white pixels into grid cells estimated as the parking lot of the target facility and inversely converting black pixels into grid cells estimated as not being the parking lot of the target facility on the monochrome image converted into the smooth image by, for example, the closing processing. As described above, the smoothing processing unit 315 can continuously smooth the set of grid cells serving as the parking lot of the target facility by applying the filter processing in the image analysis. The smoothing processing unit 315 can reduce the influence of the data variation in the boundary estimation of the facility parking lot by smoothing the section of the parking lot. In addition, the filtering processing is not limited to the above-described filtering processing. Instead of binarizing an image, for example, arbitrary filter processing may be applied to convert a gray pixelized image into a smooth image by converting the image into a gray pixel according to the size of a feature amount.

The parking lot recording unit 316 stores the shape information of the parking lot of the facility estimated by the facility parking lot estimation unit 314 in the map information storage unit 321. When smoothing is performed by the smoothing processing unit 315, the shape information of the parking lot of the facility after the smoothing processing is stored in the map information storage unit 321.

Specifically, the parking lot recording unit 316 stores the shape information of the parking lot section of the facility in the map information storage unit 321 together with the center positional information of the facility. With such a configuration, it is possible to create a map having the shape of the parking lot section without manually creating the shape of the parking lot of the facility. The configuration of each functional unit of the parking lot section estimation device 30 exemplified as the present embodiment has been described above.

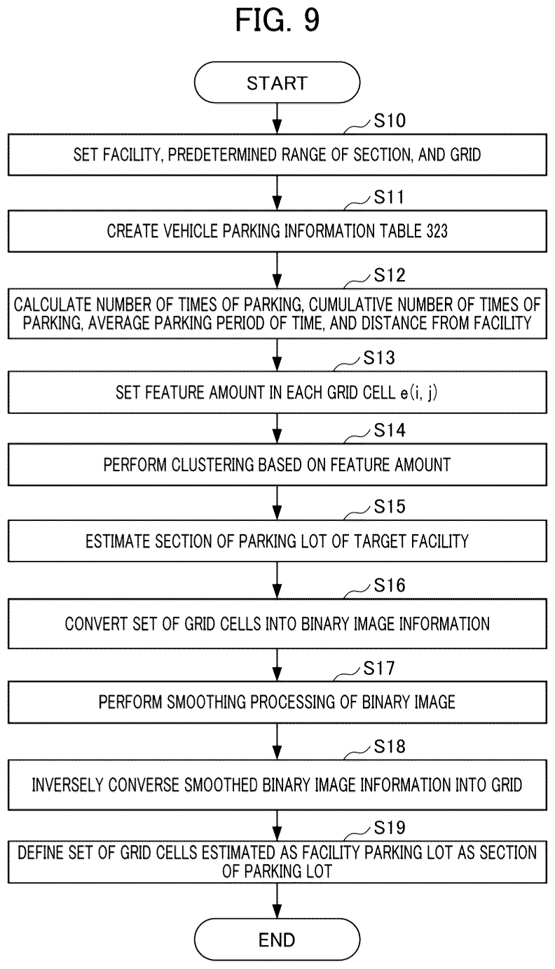

Next, the operation of the present embodiment will be described with reference to the flowchart illustrated in FIG. 9. Here, FIG. 9 is a flowchart showing an operation of estimating a section of a parking lot of one facility. In addition, operation processing in which the parking lot section estimation device 30 (the receiver unit 311) receives the identification information, the positional information, the time information, and the like of the vehicle 50 from each vehicle 50 and creates and updates the positional information database 322, and operation processing in which the parking lot section estimation device 30 (the vehicle parking information recording unit 312) determines the parking position of each vehicle 50 from the movement transition of the positional information of each vehicle 50 and determines the determination positional information, the parking time, and the like and creates and updates the vehicle parking information table 323 are well known to those skilled in the art, and thus detailed descriptions thereof will be omitted.

Referring to FIG. 9, in step S10, the parking lot section estimation device 30 (the parking feature amount calculation unit 313) selects one facility and sets the center positional information of the facility based on the map information stored in the map information storage unit 321, and the parking lot section estimation device 30 (the parking feature amount calculation unit 313) sets a section of a predetermined range including the center positional information of the facility and divides the section into N×N (N: natural number) grid cells e(i, j) (1≤i≤N, 1≤j≤N).

In step S11, the parking lot section estimation device 30 (the vehicle parking information recording unit 312) creates the vehicle parking information table 323.

In step S12, the parking lot section estimation device 30 (the parking feature amount calculation unit 313) calculates the total number of times of parking v(i, j) of the vehicles parked in the grid cell e(i, j) in a predetermined period, the total period of time (the accumulated parking period of time) s(i, j) of the vehicles parked in the grid cell e(i, j) in the predetermined period, and the average parking period of time a(i, j) per one vehicle parked in the grid cell e(i, j) in the predetermined period, for each grid cell e(i, j) based on the vehicle parking information table 323, and calculates the distance d(i, j) from the facility to the grid cell e(i, j).

In step S13, the parking lot section estimation device 30 (the facility parking lot estimation unit 314) sets, for the grid cell e(i, j), at least any one of the total number of times of parking v(i, j), the total period of time s(i, j) of the parked vehicles, and the average parking period of time a(i, j) per one vehicle parked, as the feature amount related to the parking information of the grid cell e(i, j).

In step S14, the parking lot section estimation device 30 (the facility parking lot estimation unit 314) performs clustering for classifying a set of grid cells into two clusters using the feature amount of the grid cell e(i, j) to classify grid cells estimated to be included in the parking lot of the target facility as one cluster and classifies grid cells estimated not to be included in the parking lot of the target facility as another cluster.

In step S15, the parking lot section estimation device 30 (the facility parking lot estimation unit 314) determines that the set of grid cells e(i, j) estimated to be included in the parking lot of the target facility is the parking lot of the target facility, and estimates the shape of the section of the parking lot of the target facility.

In step S16, the parking lot section estimation device 30 (the smoothing processing unit 315) associates the pixel value 1 (white pixels) with the grid cell set estimated to be the parking lot of the target facility, and associates the pixel value 0 (black pixels) with the grid cell set estimated not to be the parking lot of the target facility, thereby converting the grid cell sets into binary image information.

In step S17, the parking lot section estimation device 30 (the smoothing processing unit 315) smooths the binary image information by performing filter processing (for example, morphology processing) in image analysis on the binary image information.

In step S18, in the smoothed binary image information, the parking lot section estimation device 30 (the smoothing processing unit 315) inversely converts white pixels into grid cells estimated to be the parking lot of the target facility, and inversely converts black pixels into grid cells estimated not to be the parking lot of the target facility.

In step S19, the parking lot section estimation device 30 (the parking lot recording unit 316) stores the set of grid cells estimated as the parking lot of the target facility in step S19 in the map information storage unit 321 as the section of the parking lot of the target facility. As described above, the parking lot section estimation device 30 estimates the section of the parking lot of one facility based on the center positional information of the facility stored in the map information storage unit 321 and the plurality of pieces of parking positional information stored in the vehicle parking information table 323. The parking lot section estimation device 30 can determine the shapes of the parking lots of all facilities by performing the above-described operation on all facilities included in the map information.

According to the present embodiment described above, it is possible to provide a parking lot section estimation device and a parking lot section estimation method for estimating a section shape of a parking lot of a facility without manually creating the shape of the parking lot of the facility by calculating a feature amount related to parking information of each grid cell in a plurality of grid cells in a predetermined range from a facility position, clustering a set of grid cells using the feature amounts of the grid cells, and calculating the set of grid cells having similar feature amounts.

Each of the devices may be implemented by hardware, software, or a combination thereof. The navigation method performed by the cooperation of the respective devices included in the navigation system can also be realized by hardware, software, or a combination thereof. Here, being implemented by software indicates being implemented by a computer reading and executing a program.

The program may be stored and provided to the computer using various types of non-transitory computer readable media (non-transitory computer readable medium). Non-transitory computer readable media include various types of tangible storage media. Examples of the non-transitory computer readable medium include a magnetic recording medium (flexible disk, magnetic tape, and hard disk drive), a magneto-optical recording medium (for example, a magneto-optical disk), a CD-ROM (Read Only Memory), a CD-R, a CD-R/W, and semiconductor memory (for example, mask ROM, programmable ROM (PROM) , erasable PROM (EPROM), flash ROM, and random access memory (RAM) ). The program may also be provided to the computer by various types of temporary computer readable media (transitory computer readable medium). Examples of non-transitory computer readable media include electrical, optical, and electromagnetic signals. The non-transitory computer readable media can provide the program to the computer via wired communication paths, such as electrical wires and optical fibers, or wireless communication paths.

Although the above-described embodiment is a preferred embodiment of the present invention, the scope of the present invention is not limited to the above-described embodiment, and various modifications can be made without departing from the scope of the present invention.

### Modification 1

For example, the functional configurations of FIGS. 2, 3, and 4 are merely examples, and do not limit the functional configuration of the present embodiment. That is, it is sufficient if each device is provided with a function capable of executing a series of processes related to the vehicle position analysis function of the present invention as a whole, and what kind of functional block is used to realize this function is not particularly limited to the examples of FIGS. 2, 3, and 4. In addition, the above-described embodiment may be modified, for example, as a modification described below. It should be noted that the modification examples described below may be further combined.

### Modification 2

In the above-described embodiment, the parking lot section estimation device 30 is realized by one server device or the like, but may be a distributed processing system in which each function of the parking lot section estimation device 30 is distributed to a plurality of server devices as appropriate. In addition, each function of the parking lot section estimation device 30 may be realized using a virtual Server function or the like on the cloud.

### Modification 3

In the above-described embodiment, the parking lot section estimation device 30 is configured to receive the identification information, the positional information, the time information, and the like of the vehicle 50 from each vehicle 50 via the communication unit 33. Further, the receiver unit 311 is configured to appropriately create and update the positional information database 322 based on the identification information, the positional information, the time information, and the like received from each vehicle 50. On the other hand, for example, an FCD (Floating Car Data) server (provisional name) may be provided separately from the parking lot section estimation device 30, and the FCD server may receive identification information, positional information, time information, and the like of the vehicle 50 from each vehicle 50. In this case, the parking lot section estimation device 30 may acquire positional information and the like of each vehicle from the FCD server, and create and update the positional information database 322 (movement transition) as appropriate.

### EXPLANATION OF REFERENCE NUMERALS

1 Parking lot section estimation system
10 On-board navigation device
11 Control Unit
111 Route guidance unit
112 Positional information transmission unit
12 Storage unit
13 Communication unit
14 Sensor unit
20 Mobile terminal
21 Control Unit
111 Route guidance unit
112 Positional information transmission unit
22 Storage unit
23 Communication unit
24 Sensor unit
30 Parking lot section estimation device
31 Control Unit
311 Receiver unit
312 Vehicle parking information recording unit
313 Parking lot feature amount calculation unit
314 Facility parking lot estimation unit
315 Smoothing processing unit
316 Parking lot recording unit
32 Storage unit
321 Map information storage unit
322 Positional information database
323 Vehicle parking information table
33 Communication unit
50, 50a, 50b Vehicle
60 Communication network

1. A parking lot section estimation device comprising:
a map information storage that stores map information including center positional information of a plurality of facilities;
a receiver that receives continuous positional information together with time information from a plurality of vehicles;
a vehicle parking information recorder that determines that a vehicle has been parked in a case in which the positional information has not changed for a predetermined period of time or more, and records a parking position of the vehicle, the time information, and a parking period of time that can be calculated based on the parking position and the time information, as vehicle parking information;
a parking feature amount calculator that calculates a feature amount relating to at least any one of a parking frequency and a vehicle parking period of time in a predetermined period of time based on the vehicle parking information for each of a plurality of grid cells obtained by dividing a region included in the map information; and
a facility parking lot estimator that extracts grid cells positioned in a predetermined range from one of the plurality of facilities and performs clustering with the feature amount, to estimate a section of a parking lot of the facility.

2. The parking lot section estimation device according to claim 1, wherein the parking feature amount calculator calculates, for each of the grid cells, a total number of times of parking and an accumulated parking period of time of the total number of times of parking in the predetermined period of time, sets the total number of times of parking as a feature amount relating to the parking frequency, and sets the accumulated parking period of time of the total number of times of parking as a feature amount relating to the vehicle parking period of time.

3. The parking lot section estimation device according to claim 2, wherein the parking feature amount calculator further calculates an average parking period of time per vehicle based on the total number of times of parking and the accumulated parking period of time to set the average parking period of time per vehicle as a feature amount relating to the vehicle parking period of time.

4. The parking lot section estimation device according to claim 1, wherein the parking feature amount calculator further calculates, for each of the grid cells, a feature amount relating to distance information from the facility based on a distance from the facility.

5. The parking lot section estimation device according to claim 1, wherein the parking feature amount calculator further sets, for each of the grid cells, at least one day of a week in the predetermined period of time, and calculates a parking frequency and/or a vehicle parking period of time in a period including only a set day of the week or a period not including the set day of the week.

6. The parking lot section estimation device according to claim 1, wherein the parking feature amount calculator further calculates, for each of the grid cells, a parking frequency and/or a vehicle parking period of time in a period including only a time slot of business hours of the facility or a period including only a time slot outside the business hours of the facility.

7. The parking lot section estimation device according to claim 1, further comprising a smoothing processor that associates an image in which a pixel value 1 is associated with a grid cell estimated as a parking lot of the facility by the facility parking lot estimator or an image in which a pixel value O is associated with a grid cell estimated as not being a parking lot of the facility by the facility parking lot estimator with a corresponding one of the grid cells, and performs filtering on each of the images by a smoothing filter in image processing,
wherein the facility parking lot estimator performs filtering on each of the images by the smoothing processor to correct a section of a parking lot of the facility estimated by performing clustering with the feature amount.

8. A parking lot section estimation method executed by a computer, the method comprising:
a map information recording step of recording map information including center positional information of a plurality of facilities;
a receiving step of receiving continuous positional information together with time information from a plurality of vehicles;
a vehicle parking information recording step of determining that a vehicle has been parked in a case in which the positional information has not changed for a predetermined period of time or more, and recording a parking position of the vehicle, the time information, and a parking period of time that can be calculated based on the parking position and the time information, as vehicle parking information;
a parking feature amount calculating step of calculating a feature amount relating to at least any one of a parking frequency and a vehicle parking period of time in a predetermined period of time based on the vehicle parking information for each of a plurality of grid cells obtained by dividing a region included in the map information; and
a facility parking lot estimating step of extracting grid cells positioned in a predetermined range from a facility and performing clustering with the feature amount, to estimate a section of a parking lot of the facility.
